(19) United States
(12) Patent Application Publication
(10) Pub. No.: US 2024/0207135 A1
(43) Pub. Date: Jun. 27, 2024

(54) Tip For Massage Gun Head

(71) Applicant: RockCuff, Inc., South Jordan, UT (US)

(72) Inventor: Chett B. Paulsen, Sandy, UT (US)

(21) Appl. No.: 18/520,981

(22) Filed: Nov. 28, 2023

Related U.S. Application Data
(60) Provisional application No. 63/428,408, filed on Nov. 28, 2022.

(51) Int. Cl. A61H 23/00

(52) U.S. Cl. CPC A61H 23/006; A61H 2201/0107; A61H 2201/0153; A61H 2201/0157; A61H 2201/0165; A61H 2201/1645; A61H 2201/1664; A61H 2201/1685; A61H 2201/1695

(57) ABSTRACT

Technology is described for a tip device for a massage gun head. The device may include a removeable tip that interfaces with existing hard tips, tip with a tip body and a tip face. A support may be joined to the tip. An inner wall and end wall may be in the support and may form a void for receiving the massage gun head. The inner wall may have a smaller diameter than a massage gun head diameter. A channel may also be formed in the inner wall.

### PRIORITY DATA

This application claims the benefit of U.S. Provisional Patent Application Ser. No. 63/428,408, filed Nov. 28, 2022, which is incorporated herein by reference.

### BACKGROUND

Powered electric massage machines have been available for many years. Massage machines may be handheld or mounted into furniture such as a massage chair. Individuals may find relief in massaging aching or tense muscles. Over time, a large market has been created for various types of massaging machines. An example of one type of massaging machine that has become popular is a percussive massage gun, which uses rapid and repetitive pressure in a single direction or line using a piston-like motion. A piston motion retracts and extends the massage gun head in a motion that is similar to a jack hammer.

The percussive massage gun is suggested for use only on large muscle groups and can be used for what is referred to as trigger point therapy. The massage gun heads may be used to break up knots in a person's muscles. Some athletes like to use trigger point therapy before a work out to increase a range of motions, while others may use percussive massage guns to help reduce delayed onset muscle soreness or DOMS. During operation, the head of the massage gun is pushed into the skin so that the head contacts the underlying muscle. This type of massage gun therapy is similar to dry needling where the muscle relaxes, and circulation increases at the small area where the massage is being performed.

Massage gun devices from varying manufacturers may differ in the frequency of the oscillation and the distance travelled for the stroke of the piston-like motion. The massage gun may have a receiving chamber for a massage gun head which incorporates a receiving hole designed to accept interchangeable, hard plastic shafts with shaped ends or massage gun heads that are designed to transfer some energy generated by the piston of the device into a targeted body tissue. These massage gun heads can be made of hard plastic, (Shore A scale 60+) which incorporate rounded or convex shapes that contact the tissue. The shapes may vary in size from small bullet shapes to larger golf ball shapes. Such shafts and massage gun heads are recommended only for large, bulky muscle groups because the massage gun heads are quite hard. They are not recommended for use on the torso, neck, bony sites, shins, top of feet, head or neck. The rapid repetitive actions of percussive massage guns combined with the hard massage gun heads may bounce when the massage gun heads contact bony areas such as the ankle, shoulder, knee, and elbow causing pain. Additionally, the convex shape of the massage gun head minimizes the contact area when used on a convex point of the body like a person's shin or Achilles heel.

### BRIEF DESCRIPTION OF THE DRAWINGS

FIG. 1A illustrates a massage gun with an example of a tip for a massage gun head.

FIG. 1B illustrates that the symmetric tips or caps may be multi-colored.

FIG. 2 illustrates an example of the stroke positions for a massage gun.

FIG. 3 illustrates examples of a variety of existing massage gun heads which are provided by the manufacturers of the percussive massage guns.

FIG. 4 illustrates a chart of example durometers for the tips.

FIG. 5 illustrates the piston stroke distance that may occur with a massage gun.

FIG. 6A illustrates an example cross-sectional view of a tip which may be a symmetrical tip for the massage gun heads.

FIG. 6B illustrates a perspective view of an example symmetrical tip for a massage gun head.

FIG. 6C is a perspective view of a massage gun manufacturer provided massage gun head which is bullet shaped.

FIG. 7A illustrates a cross-sectional view of an example tip for a massage gun head that is asymmetrical.

FIG. 7B illustrates an example of a cross-sectional view an asymmetric tip that may be a semi-conical shape.

FIG. 7C illustrates an example perspective view of an asymmetrical tip.

FIG. 8A illustrates a cross-sectional view of an example tip that is a drum shape as compared to a top view of the tip and side views of the massage gun head.

FIG. 8B illustrates an example perspective view of a disc-shaped hard plastic massage gun head which may be inserted in a drum shaped tip.

FIGS. 9A-9D and FIGS. 10A-10C illustrate that tips may include layers of materials with multiple durometers on and in the tips.

FIG. 11A illustrates an example cross-sectional view of an asymmetric tip without an internal layer as compared to an asymmetric tip with an internal layer having a high durometer within the tip.

FIG. 11B is an example concave tip without an internal layer as compared to an asymmetric tip with an internal layer having a high durometer within the tip.

FIG. 12A illustrates an example of a concave tip massaging rounded tissue.

FIG. 12B illustrates an example of a concave tip massaging rounded portions of a human foot or leg.

FIG. 12C illustrates an example of a concave tip massaging rounded portions of a human hand.

FIG. 13A illustrates an example of an asymmetric tip that may be able to massage a rounded portion of tissue.

FIG. 13B illustrates an example of an asymmetric tip which may be able to effectively massage tendons, ligaments and other anatomy of a human knee joint.

FIG. 14A illustrates an example of a massage head that may have a 1/2″ throw or travel distance.

FIG. 14B illustrates an example where the silicone gel material of a tip can compress due the material's durometer and/or thickness and compress to absorb excess throw.

FIG. 15 illustrates an example of portions of the human body marked with ovals where a drum-like tip may be useful.

FIG. 16 illustrates an example of portions of the human body marked with ovals where a symmetric tip may be useful.

FIG. 17 illustrates an example of portions of the human body marked with ovals where an asymmetric tip may be useful.

FIG. 18 illustrates an example of portions of the human body marked with ovals where a concave tip may be useful.

FIG. 19 illustrates engagement areas for a massage gun head which has a hard plastic end based on a ½″ throw and a ¼″ tissue thickness.

FIG. 20 illustrates an example of tip (e.g., made of silicone with platinum) engagement areas based on a ½″ throw and ¼″ tissue thickness.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

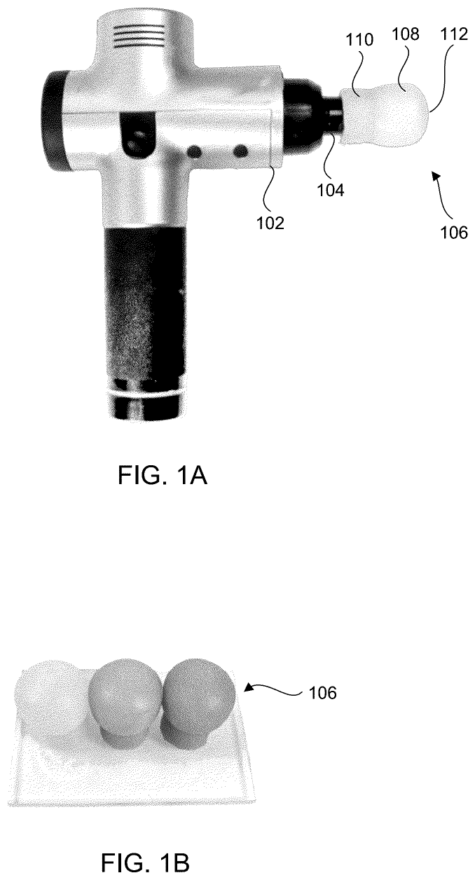

FIG. 1A illustrates a symmetric tip 106 for a massage gun head 104 that is mounted in the massage gun 102. The massage gun head 104 is removably held by the massage gun 102 and can be replaced by the user of the massage gun 102 by pulling the massage gun head 104 out of the massage gun 102. For example, the massage gun heads 104 may be press fit and held in place in the massage gun 102 using friction in the previously existing percussive gun designs or other attachment mechanisms. The symmetric tip may have a tip body 108 and a support 110 attached to the tip body 108. The tip body 108 may also have a tip face 112 which can be used for contact with the anatomical structure (e.g., skin) of the person receiving a massage. In one configuration, the tip body 108 is has an outer annular wall and/or a bulbous shape. The tip face 112 may be a flattened dome as illustrated in FIG. 1A or the tip face may be other shapes as described later (e.g., dome, angular, drum, concave, convex, etc.)

FIG. 1B illustrates that the symmetric tips 106 or caps may be multi-colored. These tips 106 (e.g., head covers or caps) may be designed to be fit over existing OEM (original equipment manufacturer) massage gun heads 104 that are used in massage guns 102. In an alternative configuration, the tips 106 (e.g., covers or caps) may be permanently or semi-permanently fixed, attached, glued, threaded, removably coupled or otherwise attached to the massage gun head 104. The massage gun heads 104 may be inserted into or otherwise incorporated into the massage gun 102 or even affixed or attached to the massage gun 102.

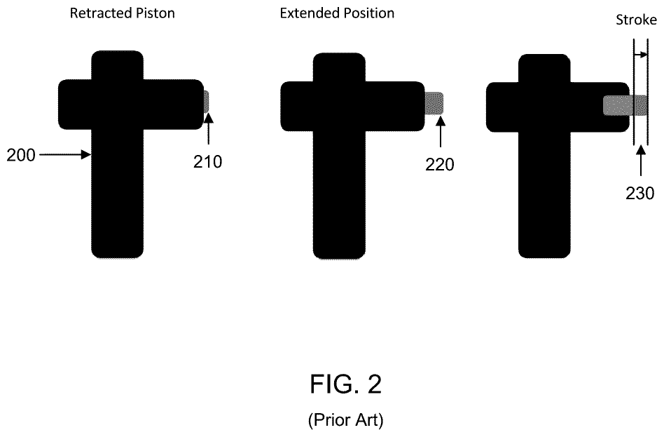

FIG. 2 illustrates an example of the stroke positioning of a massage gun 200. The massage gun 200 may move the massage gun head to a retracted stroke position 210. The massage gun can also move the massage gun head to an extended position 220. The difference between these two positions can considered the total stroke distance 230.

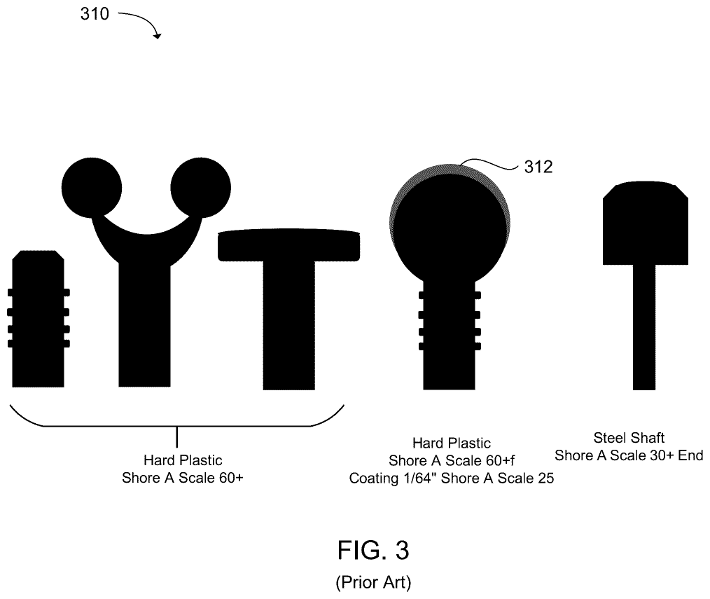

FIG. 3 illustrates examples of prior massage gun heads 310 which are provided by some manufacturers of massage guns. These massage gun heads are made of hard plastic with a hard durometer as compared to human tissue. For example, massage gun heads may be made of hard plastic that is rated 60+ on the Shore A hardness scale. Some of the massage gun heads may have a thin foam or rubber coating 312, but that foam coating may be 25+ on the Shore A hardness scale and is only a very thin coating less than 1/10^{th} of an inch. Durometer refers to the amount of compression that can be obtained out of a material.

The hard heads contact tissue in a small or tiny area, and transfer energy to a human body in a small or tiny area. For example, if the percussive massage gun is held away from the surface of the skin at a distance that is greater than the stroke of the gun, the head will not contact the skin. As the distance of the gun from the skin is reduced, the head begins to repeatedly tap the skin. As the head of the gun is pressed into the tissue, the head compresses the skin and underlying tissue in the shape of the head delivering the maximum amount of pressure at the apex of the head shape. The percussive force (if measured at 100% at the apex) will measure less than full pressure along the face of the head that is not at the apex. Consider the effect of pushing the end of a pen or a golf ball into a pillow. The very center receives the force while the sides of the object become ineffective. The bigger the muscle area and muscle thickness, the more effective the previously existing massage guns are at transferring the energy into the tissue with hard massage gun heads. The converse may also be true. The smaller the muscle area and muscle thickness, the less effective the previously existing massage guns are at transferring the energy into the tissue with hard massage gun heads.

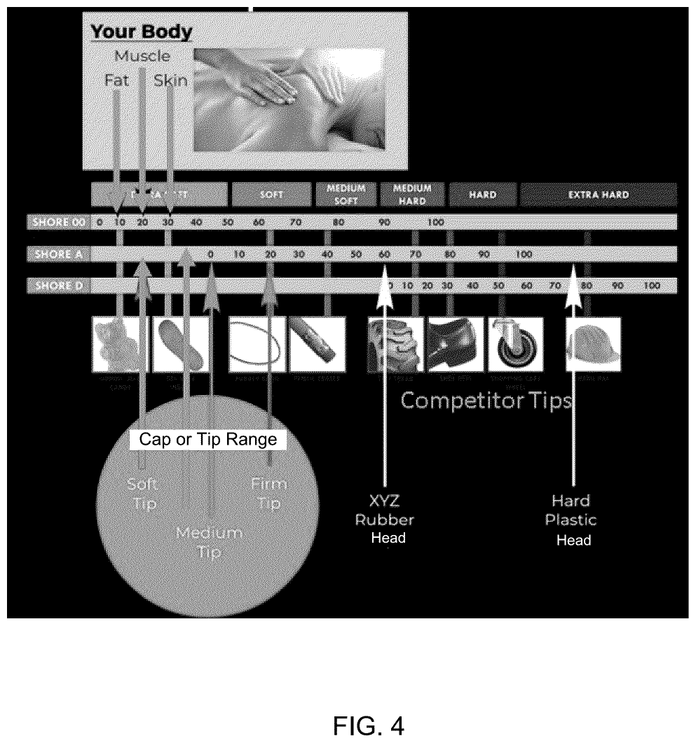

FIG. 4 illustrates a chart of example durometers for various materials. The chart is overlaid with prior art massage gun heads and also illustrates the durometers of the tips of the present technology. The durometer of the tips can vary from tip to tip and can be designed specifically for the durometer of the human tissue, type of human tissue, and/or durometer and compressive features of the tip material. The tip materials may also take into consideration the percussive devices repetition frequency and the throw of the device. For example, certain tips may be designed for the temples on the head or the knees. Using a durometer for the tips that is comparable to human tissue allows the tips to be used on anatomical areas of a massage recipient where the use of a percussion massage was previously contraindicated or might have otherwise been dangerous. These tips may also be used on areas of the body where percussion massage is contraindicated and has been generally ineffective, painful or even damaging. For instance, using percussion massage in the past on areas where the tissue was either thin (e.g., the shin) or there are mixed tissues (such as the knee joint) was difficult but with a desirable soft durometer, the tip may make percussion massage on such anatomical areas effective and useful.

A tip constructed using a concave shape or softer material than hard plastic, can provide an entirely different effect using the same rapid, repetitive motion of massage guns. For example, the material may be something such as medical grade silicone with platinum, silicone with tin, pure silicone, thermoplastic elastomer (TPE) or similar soft materials. More specifically, the tips may be constructed of material with durometers that are equivalent to or substantially close to the durometer of human tissue, as compared on the Shore 00 Scale. For example, human fat is a 10, muscle is a 20 and skin is 30 on the Shore 00 scale. The durometer of a tip may be set to simulate a human hand, heel of the hand, the thumb, the fingers or other parts of the human hand during a massage. The durometer and the shape of the tip may be designed based on the anticipated area of use on the body, the underlying tissue, and the desired outcome.

In one configuration, the tips may incorporate material with enough thickness between the hard plastic of the massage gun head and the outer edge of the tip to fully incorporate or compensate for the massage gun's “stroke” without reaching the tip material's full compression state. For example, if the known distance of the stroke is ¼ inch then extra material can be provided in the tip so the tip can compress ¼ inch without the user feeling the hard material of the massage gun head. Of course, more total material may be required than ¼ inch for the compression to not exceed the ¼ inch. For example, ½ inch of tip material may be provided that can compress down ¼ inch before reaching the tip material's full compression state.

Using a low durometer material as compared to the skin, muscle or fat can provide the ability to make micro durometer adjustments during a massage session. The user can control the amount of pressure being applied to the skin by the amount a tip is compressed. Unlike hard plastic tips where the pressure is either applied or not applied, an increasingly compressed material can deliver increasing amounts of consistent pressure. Since a low durometer material compresses well until the maximum compression point (e.g., 20% to 35% of the tips original thickness), then the massage technician or user can control the pressure during a significant amount of compression in the tip. This compression may be linear or logarithmic depending on the low durometer and/or composition of the material used to make the tip.

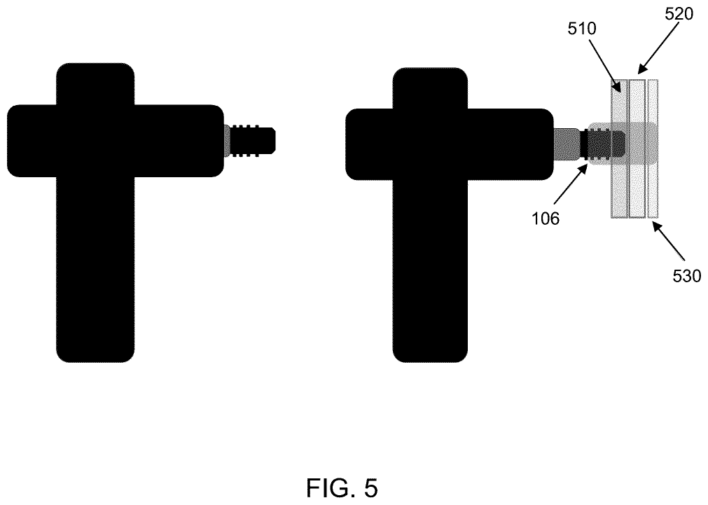

FIG. 5 illustrates the piston stroke distance 510 that may occur. The massage gun may work on an oscillation frequency. The piston stoke distance 510 may be considered the stroke or distance of travel. The massage gun head 106 may travel a defined distance into the massage gun and then out of the massage gun. The prior hard plastic heads for massage guns tend to work better on locations of human anatomy where the person has more tissue (e.g., muscle) thickness than the gun has throw, at the point that is being massaged. If the massage gun head is able to completely compress the tissue and then hits a bone, the result is that the hard plastic massage gun head can hurt the person being massaged. In a sense, the present soft tip is providing the additional amount of material in the tip itself in order to maximize the areas of use.

A certain portion of the silicone gel or material in a tip 520 may compress due to that stroke distance. However, a certain thickness of the tip 530 will remain as a margin after the gel or material is fully compressed. The margin or material protects the user against pain or discomfort on harder tissues or bone as the massage gun head and massage gun piston are moving in and out quickly.

As mentioned, the massage guns are most comfortable for users or patients where there is enough tissue that when the tissue is fully compressed, then the massage gun head does not hit a bony structure. Once the massage gun head hits a bony structure, then the massage gun head just bounces off the bony anatomical structure. This can be quite uncomfortable to the user or patient. If the thickness of the tissue is less than the throw in previously existing massage gun heads, the massage gun head can hit the bony structure and bounce off of the anatomical structure. The silicone material in the tips of this technology can compress but leave a residual amount of material or silicone between the massage gun and the hard tissue to avoid such bouncing off of the anatomical structure.

As a result, the material of the tips may have enough thickness and durometer that all of the material in the tip will not be completely compressed when the throw of the head is completed. If the material is completely compressed, then the tip may become hard and uncomfortable to the user.

In one configuration of this device, the tips may be installed onto and over existing massage gun heads provided with the massage gun. In another, the tips may be integrated with the massage gun head and/or massage gun as a whole. In yet another, the tips may include an integral plastic base that is inseparable from the soft tip, which is installed on the massage gun in much the same configuration as the hard plastic massage gun head. In this case, a tip device for a massage gun head may include a tip with a tip body and a tip face. A support may have a first support face that can be joined to the tip, and the support may have a second face. The second face may be affixed to the massage gun head. The second face may be concave in shape in order to be fixed or glued to the convex massage gun head.

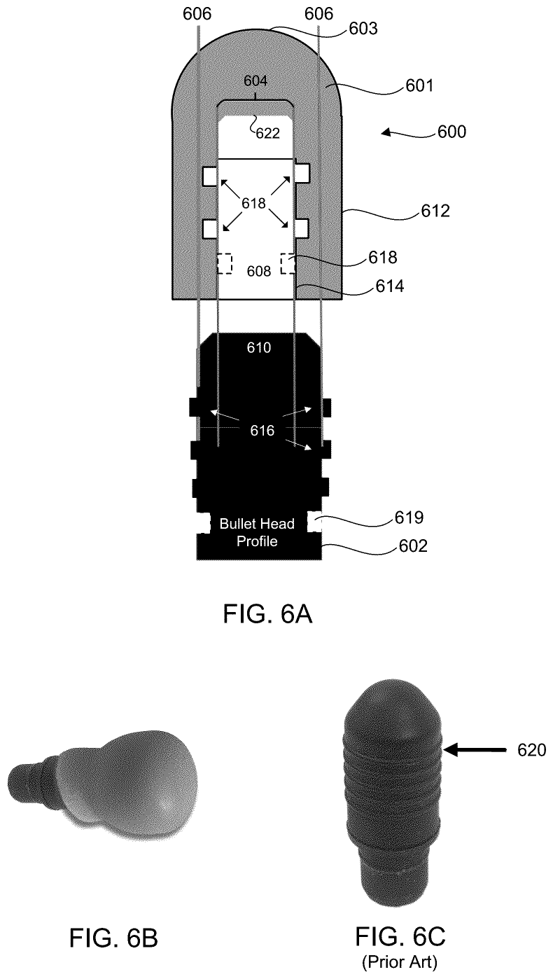

The shape of the tips or covers in this technology may be shapes prepared for use on specific areas of the anatomy. FIG. 6A illustrates a tip 600 or cap which may be a symmetrical tip for the massage gun's hard plastic head 602. The tip 600 may be formed to cover what can be considered a bullet shaped massage gun head 602. The tip may include a tip body 601 and a tip face 603. A support 612 may be joined to or may be integral to the tip 600. The support 612 may be cylindrical in shape, square, rectangular or another geometric cross-sectional shape. An inner wall (e.g., cylindrical wall) 614 and end wall 622 in the support 612 can form a void 608 for receiving the massage gun head 602. The inner wall 614 may have a smaller diameter than massage gun head diameter. At least one channel 618 or slot may be formed in the inner wall 614. The channel 618 may be an annular channel which is in a plane perpendicular to the lengthwise axis of the tip 600 and support 612.

In the tip 600, the width 604 of a void 608 formed in the tip material may be some percentage (e.g. 90% or less) than the width 606 of the massage gun head 602 (e.g., the OEM tip) in order to receive and hold the massage gun head 602. The compression of the material of the tip 600 over the massage gun head 602 can help to hold the tip 600 on the massage gun head 602. The open end of the void 608 can cover the shape 610 of the OEM tip for symmetrically shaped tips or caps.

Annular slots 618, annular channels, annular grooves or threaded channels inside the tip or cap can be used to engage with annular ridges 616 or rings on the massage gun heads 602 to minimize tip rejection or sliding as the tip 600 extends and retracts at high speed on the massage gun head 602. Alternatively and/or optionally, one or more raised annular ridges 618 may be formed on the inner wall 614 and the slots 619 may be on the massage gun head 602 to enable the tip to resist slipping from the massage gun head 616. The channels or slots may have rounded, grooved, or substantially ninety-degree corners in the channel and at the lip of the channel.

FIG. 6B. is a perspective view of a soft tip or cover on a hard plastic massage gun head. FIG. 6C is a perspective view of a hard plastic bullet shaped massage gun head 620 as previously manufactured by OEM manufacturers.

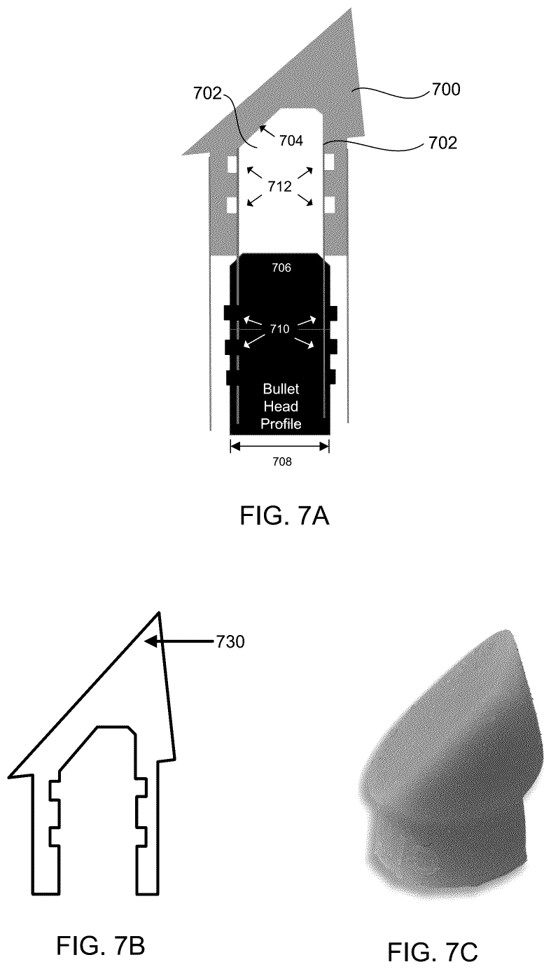

FIG. 7A illustrates a cross-sectional view of a tip 700 or cover for a massage gun head that is asymmetrical. Under the tip 700, the width 702 of a void may be some percentage (e.g. 90% or less) than the width 708 of the massage gun head 706 (e.g., the OEM tip). When the width 702 of the void for the tip or cover is less than the width of the massage gun head 706 (which is a hard plastic tip), then this means the side wall of the tip or cover can expand out but the compression of the side wall of the tip can help keep the tip on the massage gun head or hard plastic head. The end of the void 704 may match a portion of the shape (but not the size) of the head's external surface area 706 for asymmetrically shaped tips or covers which can provide more efficient and consistent transfer of energy across the tip. Annular slots 712, annular channels or swirls may be formed inside the tip 700 or cover to engage with annular rings 710, annular ridges or annular swirls on the massage gun heads. Thus, there may be ridges inside the tip to engage with slots or ridges on the massage gun head. In one example, the massage gun head may have either slots or ridges which may cause the ridges on the tip to be held in place and not pass the slots or ridges on the massage gun head.

This asymmetric shape may also provide for the asymmetrical application of force across the soft tips. The end point of the asymmetric shape may receive less energy than the portion of the tip directly over the hard head. By using the point, less energy can be applied to the anatomy of a human recipient. By changing the angle of attack, the tip may engage with more force as desired.

As explained, the hard massage gun heads or massage devices can create discomfort for a user. Such hard massage gun heads are intended to help a user get rid of their piriformis problems. In contrast, this technology is intended to simulate a regular massage. The silicone tips can be used to drive hydration into the joints, such as the Achilles heel or shin. In addition, the soft silicone tips can be used for massaging the lymph system, the head and the neck. The asymmetric tip also has useful applications where ligaments and muscles attach to bone. A massage technician may work joints because a massage with a silicone tip can drive hydration and repair for a joint. This soft massage is in sharp contrast to “scraping” with IASTM tools which can be very uncomfortable to the person receiving the scraping treatment. The soft tips can also be used where the amount of the tissue encountered by the tip is less than the stroke of the massage gun head or piston.

FIG. 7B illustrates that the point of the asymmetric tip may be a semi-conical shape where the ridge or point of the tip is not on the tip's lengthwise axis but is off to one side of the tip's lengthwise axis. To form this asymmetric shape, a plane may cut through a substantially spherical tip or cylindrical tip to form the ridge and planar face. Other conical, semi-conical, pyramidal, or cross cut shapes may be used to provide a ridge or pointed end. FIG. 7C illustrates a perspective view of an asymmetrical tip.

The asymmetric tip can also be useful to a massage technician or user to reduce ergonomic strain when performing massaging using a massage gun. With an asymmetrical tip, the person performing the massaging does not have to change their arm position to obtain a different angle into a joint for the massage. The user or massage technician can rotate the edge or ridge of the asymmetric tip to change the angle of the tip during the massage. In other words, the tip orientation may be rotated on the massage gun head to improve ergonomic orientation for a user of the massage gun. This changing of orientations works well for accessing and massaging tendons, ligaments, shins or joints. For example, when the Achilles tendon is being massaged but the user has the asymmetric tip in the wrong orientation for an effective massage, then the user can rotate asymmetric tip to work into the tendon better. Accordingly, the tip can be oriented for any ergonomic purposes of the healthcare provider, massage professional or user.

The asymmetric tip allows the user to massage around the bony structures and drive hydration to near the bone. Because the body activates healing and repair based on crisis, this type of massage therapy tells the body where repair is to occur. The massage can also provide increased circulation which promotes healing by the body because hormones are then supplied by the body to the massaged site.

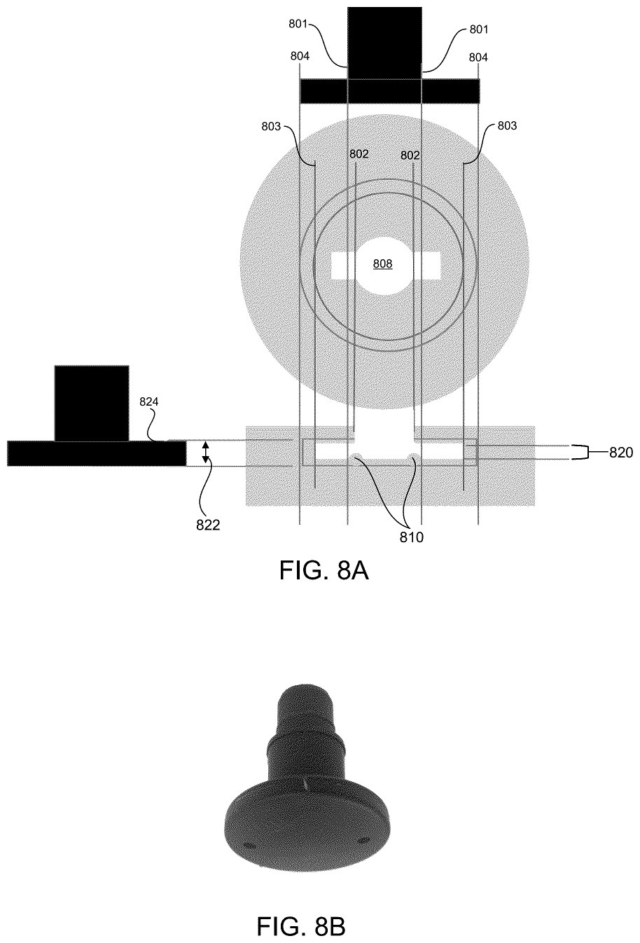

FIG. 8A illustrates a tip or cap that is a drum shape. This may be also be considered a “hockey puck” shape that is able to be fit over a round but flat massage gun head (e.g., also in a drum or hockey puck shape). In this example, the width of the hole 802 accessing the void is 90% or less than the measured width of the shaft 801 of the OEM massage gun head. The width of void 803 in the tip or cap is 90% or less than the measured width 804 of the OEM massage gun head. FIG. 8B illustrates an existing or prior hard plastic head, disk or drum shaped hard plastic massage gun head that can fit inside the drum shaped tip.

The height of the void 820 in the tip or cover can be less than the measured height 822 of the OEM massage gun head 824. The void in this drum shaped tip may have raised mounds 810 or buttons to reduce tip rotation of the massage head or reduce slippage within the void. The mounds 810 or protrusions inside the drum shaped tip can be any geometric shape (horizontally or vertically), including: pyramids, hemispheres, triangles, divots, circles, squares, cubes, etc.

The tip may include a keyhole slot 808 for easy mounting and/or removal of the massage gun head. The keyhole shape may enable the flat disk shaped, massage gun head to be placed into the void with less ripping of the tip and with enough head coverage or friction to stop the head from being pulled out. The massage gun head can be oriented where the flat portion of the massage gun head 824 is sideways to the tip and tip hole 802 to enable the tip to pass through the keyhole and rotate into the tip. The hard plastic tip is placed over the keyhole and the soft tip is stretched to accept the hard plastic tip. The drum like tip may have enough material so that when compression occurs there is still material that has not completely compressed.

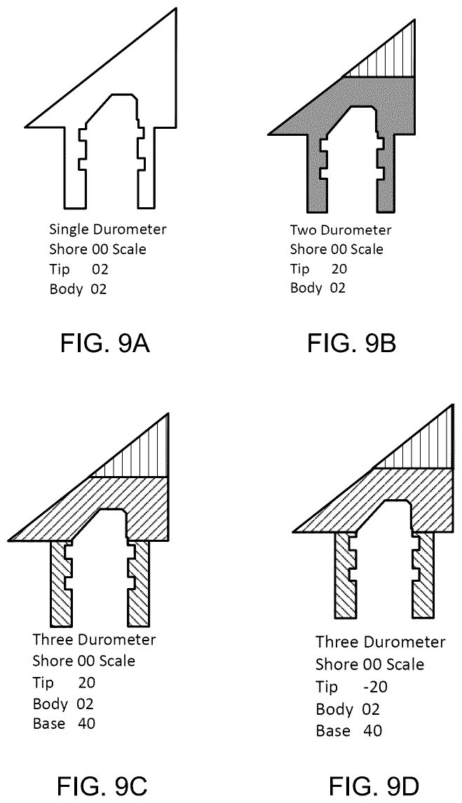

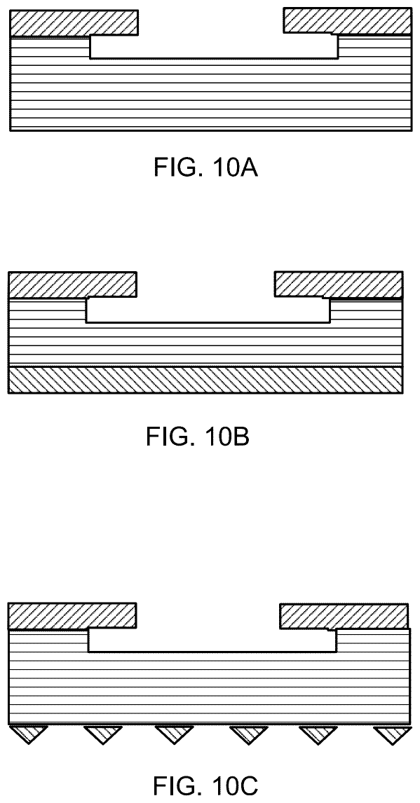

FIGS. 9A-9D and FIGS. 10A-10C illustrate that the tips may include multiple layers of materials with varying durometers in the tips or covers. The use of multiple durometer materials in the face of a tip or cover may deliver specific results. This result may be a combination of: deeper tissue massage and flexibility of the tip but with added durability (harder) of the tip. An area or layer with a higher durometer can be used to maintain the stability of a soft tip or to shape the area of delivery of force for the massage gun.

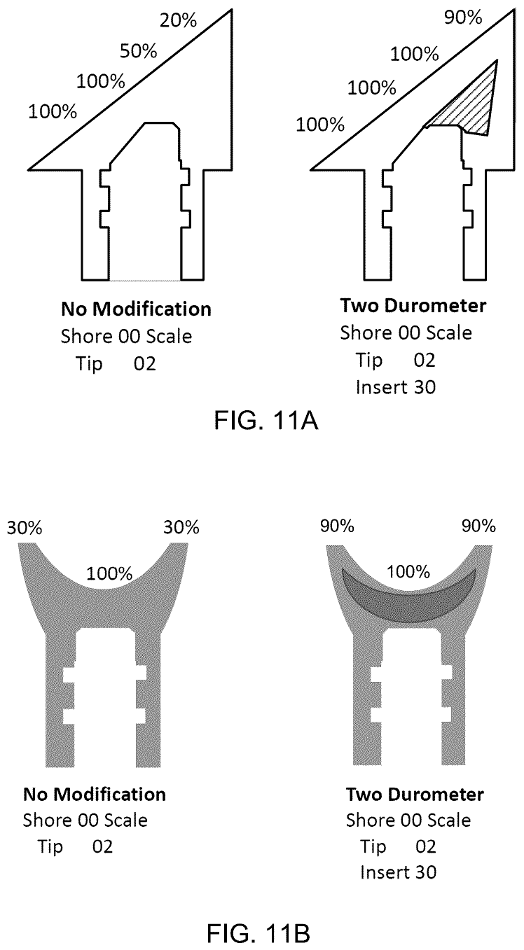

FIGS. 11A and 11B illustrate tips with multiple layers of varying durometer. The use of multiple durometer materials in the internal structure of the tip or cover can modify energy transfer for more consistent “rigidness” across the shape of the tip while maintaining softness on the external layer or face of the tip. The tip may be in a shape that conforms to the external expression of the internal design to transfer energy more efficiently where consistent pressure is desired. FIG. 11A illustrates an asymmetric tip without an internal layer as compared to an asymmetric tip with an insert with a high durometer of 30 within the tip. FIG. 11B illustrates a concave tip without an insert as compared to an asymmetric tip with an insert that has a high durometer of 30 within the tip. The percentages on FIGS. 11A and 11B illustrate the amount of energy transfer at an outside face depending on the internal structure.

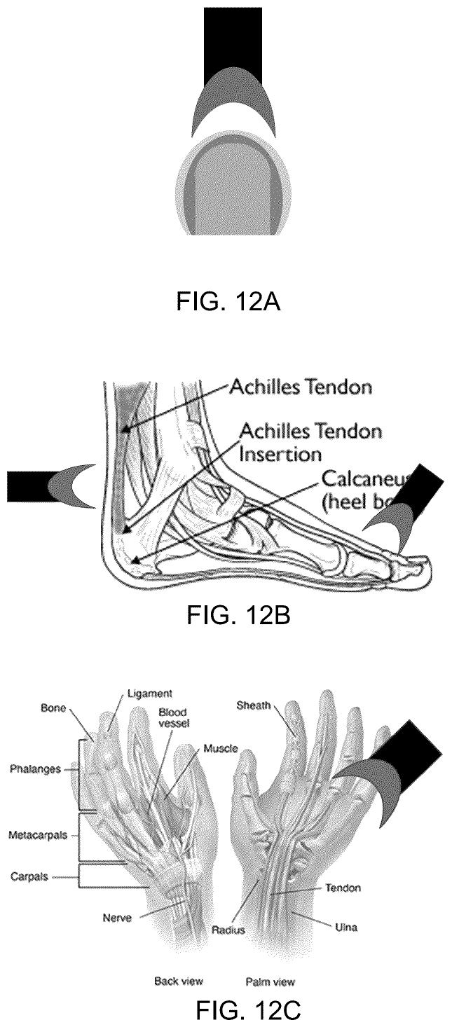

FIG. 12A illustrates a concave shaped tip that can effectively massage rounded areas or convex areas of human tissue while distributing the massage energy more evenly on the rounded anatomical structure. Many human body parts are convex. This technology provides a concave tip. A convex tip that is hard does not transfer much energy to human tissue (think tapping a golf ball against a golf ball) but a concave tip transfers more energy to the body (especially convex body parts) during a massage. In this configuration, the concave tip has two ridges that are parallel to one another and do not cross the lengthwise axis of the tip but are rather on each side of the lengthwise axis.

FIG. 12B illustrates an example of a concave tip massaging rounded portions of a human foot, in particular, the Achilles tendon. It can be helpful to have special tip shapes to be able to massage over convex body parts or into the joints or knee. This type of massage may also help individuals who cannot tolerate scraping. The results of massaging joints with these tips is that the massage can provide more circulation in the massaged area. FIG. 12C illustrates an example of a concave tip massaging rounded or convex portions of a human hand.

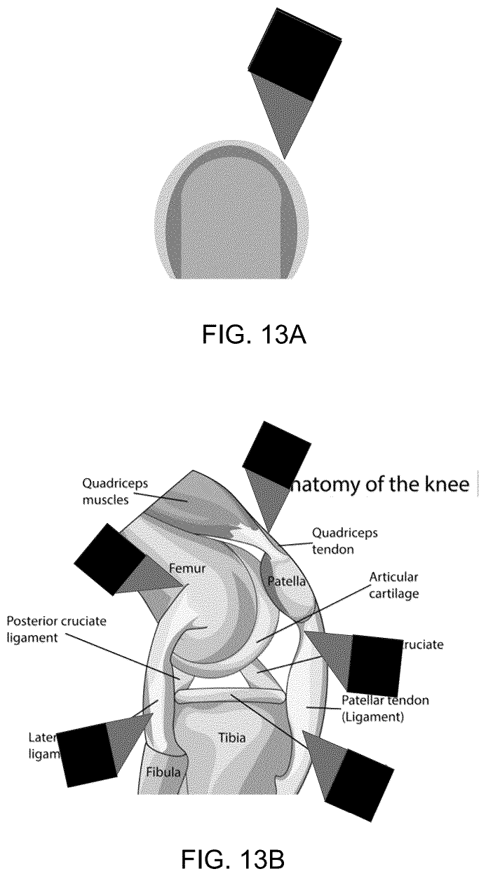

FIG. 13A illustrates that an asymmetric tip may be able to massage a rounded or convex portion of tissue. Furthermore, the asymmetric tip may be able to massage into a rounded tissue area, such as joint where muscles or ligaments connect to bone. FIG. 13B illustrates that an asymmetric tip maybe able to effectively massage tendons, ligaments and into other structures in a human joint.

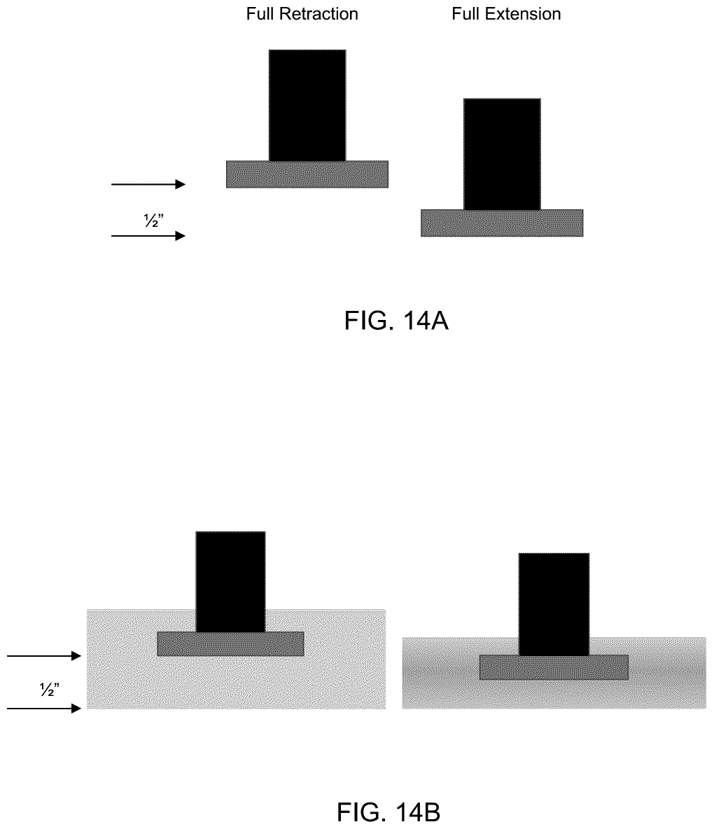

FIG. 14A illustrates that the massage head may have an example ½″ throw or travel distance. FIG. 14B illustrates that a silicone gel material over the massage head of FIG.

14A can compress due the material's durometer and/or thickness and compress to absorb excess throw. The tissue thickness may be ¼″ and the gel thickness may be ½″ over the hard plastic head. Thus, the excess throw may be absorbed by the gel material. Rubber heads with voids in the heads do not absorb this force because after the void in the rubber head is compressed, then the hardness of the head is equal again to the rubber head material.

In another example, if the throw of the massage gun is ½ inch and the tip may be known to compress 50% to ¼ of an inch. Then the combination of the ½ thick tip and the tissue that is ¼ inch can be enough to absorb the ½ inch throw without making the user uncomfortable by hitting bone or hard tissue. The amount a material compresses may depend on the type of material being used and the material's durometer. Some materials may compress to 20% of their original thickness and others may compress to 35% of their original thickness.

If a tip is going to be used over a bony structure, then the use of a low durometer is desirable, which provides more compressibility. Examples of places where a low durometer and a tip thickness of more than ½ inch is desirable may include: a shoulder, a knee, an elbow, a wrist, or an ankle.

The tips can be color coded based on the durometer of the material. This allows a massage technician or user to match durometers to the part of the body to be massaged by looking at the color of the tip. As described earlier, the durometer of the tip may simulate a palm of a hand or a tip of the thumb.

The thickness of the tip that is picked can correspond to the thickness of the tissue being massaged. Thickness, durometer and shape can be selected based on desired treatment options and body part locations to be massaged. For example, the asymmetric tip may be used on the jaw but not on the calves because the asymmetric tip is not likely to be effective on a large muscle group. The asymmetric tip may be useful for the head, neck, temple, bony structures, etc., but the asymmetric tip would not be used on the pectoralis muscles. In the past, the hard plastic heads could only address large tissues areas. Whereas, these soft tips are very versatile because of the low durometer.

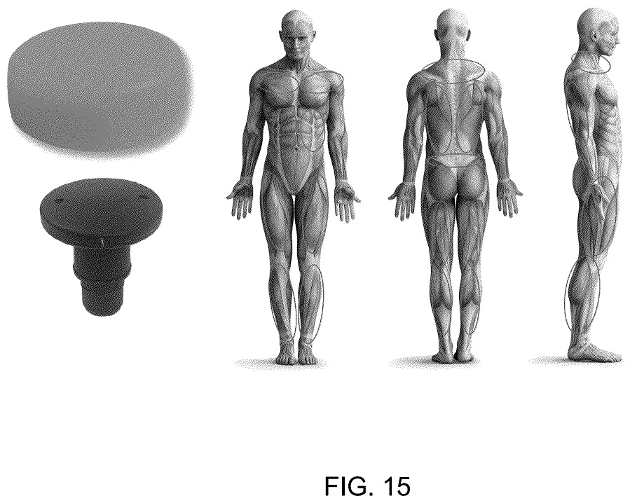

FIG. 15 illustrates an example of portions of the human body where the drum shaped tip may be useful. The areas where the drum shaped tip may be used are illustrated in ovals on the anatomical images. The shape of the tip and massage gun head are shown to the left of the anatomical image. The soft durometer of this tip can drive a lot of circulation very quickly in the big muscle groups in the ovals.

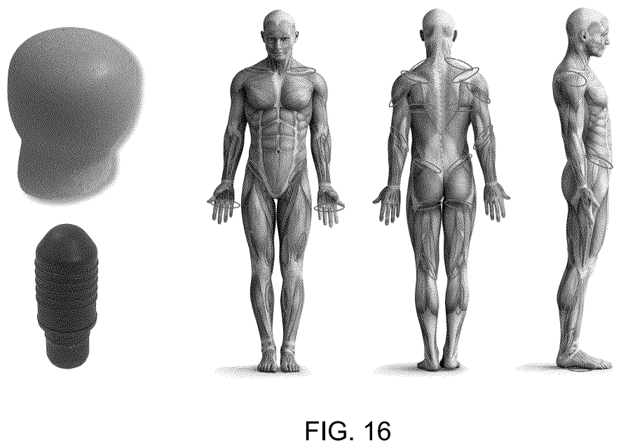

FIG. 16 illustrates an example of portions of the human body where a symmetric tip or cover may be useful. The areas where the symmetric tip may be used are in ovals on the anatomical images. The symmetric tip and massage gun head are shown to the left of the anatomical images.

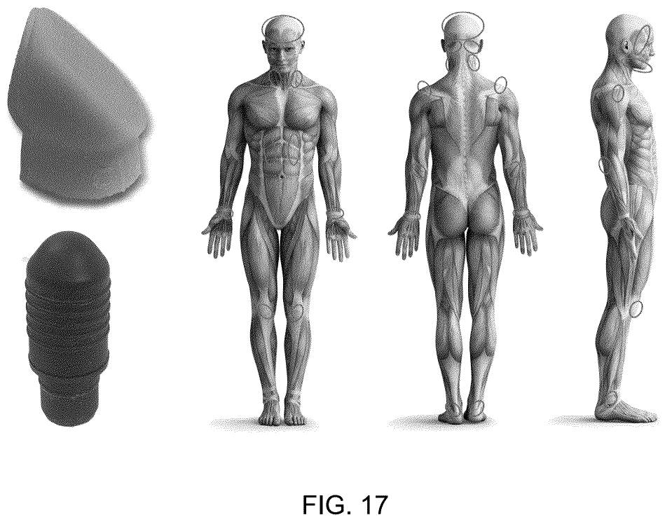

FIG. 17 illustrates an example of portions of the human body where an asymmetric tip may be useful. The areas where the asymmetric tip may be used are in ovals on the anatomical images. The asymmetric tip and massage gun head are shown to the left of the anatomical images.

This technology has advantages over other types of massages such as prior oscillating and percussive massagers due to using low durometer material. These low durometer tips can deliver benefits in the joints because the oscillating motion is massaging into the joints, tendons, ligaments, etc.

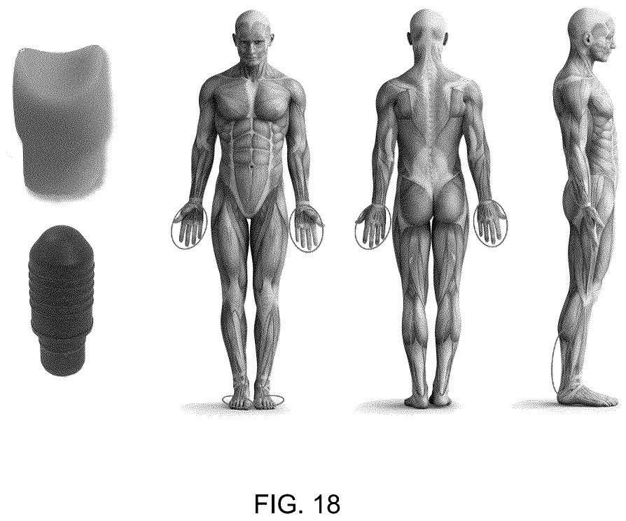

FIG. 18 illustrates an example of portions of the human body where a concave tip may be useful. The areas where the concave tip may be used on the human body are in ovals on the anatomical images. The concave tip and massage gun head are shown to the left of the anatomical images.

The shape of a tip can correspond to the massage purpose of the tip as illustrated in FIGS. 15-18. Similarly, a color of the silicone for the tip may be defined based on a purpose of the massage or a durometer of the silicone. For example, pink silicone may represent a tip with a soft durometer, and the tip is for use on bony areas. Further, a purple colored silicone tip may have a harder durometer and may be used on large muscle groups.

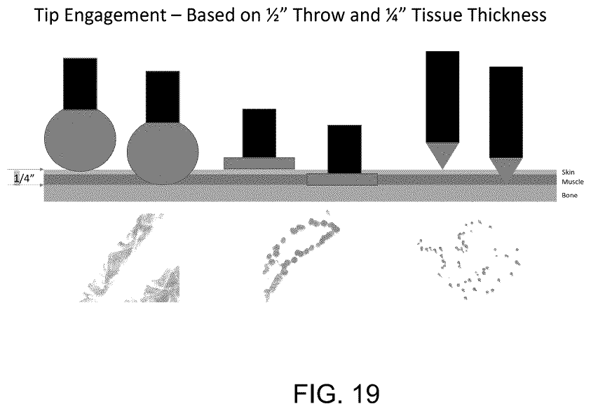

FIG. 19 illustrates engagement of a massage gun head with a hard plastic tip based on a ½″ throw and a ¼″ tissue thickness. The patterns below the tips represent the minimal amount of tip engagement with a surface, as detected using pressure sensitive paper.

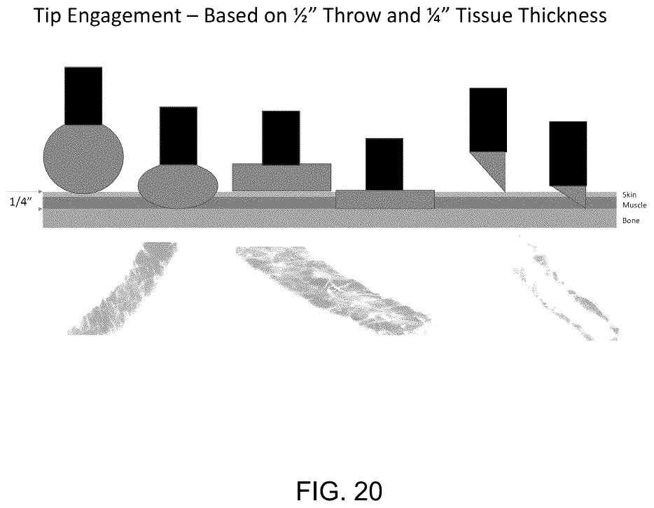

FIG. 20 illustrates soft durometer tip engagement (e.g., made of silicone with platinum) based on ½″ throw and ¼″ tissue thickness. The patterns below the tips represent increased engagement of the soft durometer tips as may be detected using pressure sensitive paper. The material used for the soft durometer tips compresses down and engages more tissue rather than just pushing through the tissue or engaging just the top side of the tissue, as with hard durometer tips. The increased amount of engaged tissue can be seen in FIG. 20 as compared to FIG. 19.

The present technology can be used as a recovery device to massage and stimulate healing in muscles, joints and other anatomical areas. These tips can also assist with injury prevention by warming up anatomical areas of the body that a person or athlete may consider is prone to injury. The tips can also be can be used in the fields of fitness and physical training.

The present soft durometer tips can be manufactured using a one-part mold, as opposed to previously known two-part molds that are used for molding in manufacturing. The mold material may be made of 35 durometer material (e.g., like a pencil eraser type of consistency). The softer silicone material that is less than 30 durometer may then be poured into the mold. Once the silicone material has cured, then the tips can be pulled out of the mold. If the mold was not made of bendable or pliable mold material, it would not be possible to pull the new tip out without damaging the tip material. Thus, this process uses a semi-malleable mold to form the malleable tip. In the past, molds have been made from hard materials such as plaster, concrete, or metal.

The described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A device to be used on a massage gun head, comprising:
a tip with a tip body and a tip face;
a support attached to the tip;
an inner wall and end wall in the support that forms a void for receiving the massage gun head, wherein the inner wall has smaller diameter than a massage gun head diameter; and
a channel formed in the inner wall.

2. The device as in claim 1, wherein the diameter of the inner wall is 90% or less of the massage gun head diameter.

3. The device as in claim 1, wherein channel is annular and has substantially ninety-degree or rounded corners.

4. The device as in claim 1, wherein the tip is formed from medical grade silicone containing platinum or a material with a durometer of between 10 to 65 on the Shore 00 scale or 0 to 20 on the Shore A scale.

5. The device as in claim 4, wherein a durometer value of silicone is selected to match the durometer value of a portion of a human hand of between 10 to 30 on the Shore 00 scale.

6. The device as in claim 1, further comprising one or more channels formed in the inner wall to resist slipping of the massage gun head.

7. The device as in claim 1, further comprising one or more raised annular ridges the inner wall to resist slipping from the massage gun head.

8. The device as in claim 1, further comprising one or more hemispherical protrusions from the inner wall or end wall to resist slipping of the massage gun head.

9. The device as in claim 1, wherein a shape of a tip corresponds to a massage purpose for the tip.

10. The device as in claim 1, wherein a color of the tip is defined by a purpose of a massage location for the tip or a durometer of the tip.

11. The device as in claim 1, wherein a thickness of the tip is greater than a throw distance of a massage gun to absorb the throw distance of the massage gun head.

12. The device as in claim 1, wherein tip orientation may be rotated on the massage gun head to improve ergonomic orientation for a user of a massage gun and the tip.

13. The device as in claim 1, wherein the tip face is symmetric, asymmetric, drum shaped, concave or convex.

14. A device for a massage gun head, comprising:
a tip with a tip body and a tip face;
a support having the tip face joined to the tip;
a second face on the support; and
a massage gun head, wherein the second face is permanently affixed to the massage gun head.

15. The tip device as in claim 14, wherein the second face is concave in shape and the massage gun head is convex.

16. A device to be used on a massage gun head, comprising:
a tip with a tip body and a tip face;
a support attached to the tip, wherein the support has cylindrical outer wall;
an inner wall and end wall in the support that forms a void for receiving the massage gun head, wherein the inner wall has smaller diameter than a massage gun head diameter; and
a channel formed in the inner wall.

17. The device as in claim 16, wherein a thickness of the tip is greater than a throw distance of a massage gun to absorb the throw distance of the massage gun head.

18. The device as in claim 16, wherein tip orientation may be rotated on the massage gun head to improve ergonomic orientation for a user of a massage gun and the tip.

19. The device as in claim 16, wherein the tip face is bulbous, symmetric, asymmetric, drum shaped, concave or convex.

20. The device as in claim 16, wherein the tip face is an asymmetric conical shape.
